(19) United States
(12) Patent Application Publication
(10) Pub. No.: US 2016/0010704 A1
(43) Pub. Date: Jan. 14, 2016

(54) Hydraulically-Driven Flywheel Uninterruptable Power Supply

(71) Applicant: Bassem Soueidan, Dubai (AE)

(72) Inventor: Bassem Soueidan, Dubai (AE)

(21) Appl. No.: 14/328,903

(22) Filed: Jul. 11, 2014

(51) Int. Cl. F16D 33/02; F16D 48/02; F16D 48/06

(52) U.S. Cl. CPC F16D 33/02; F16D 48/066; F16D 48/02; F16D 2048/0203; F16D 2048/0221

(57) ABSTRACT

Apparatus, system and method for providing supplementary power. A vessel is configured to receive and contain hydraulic fluid, where the vessel includes a piston configured within the vessel to be vertically displaced by the hydraulic fluid and provide pressure from the weight of the piston to a fluid supply line. A solenoid valve is operatively coupled to the fluid supply line; and connected to a flywheel power supply that includes a flywheel and a hydraulic drive adapter, wherein the hydraulic drive adapter is operatively coupled to the solenoid valve via the fluid supply line. A signal is received indicating a power outage, where the solenoid valve is further configured to open in response to the signal and provide the hydraulic fluid pressurized by the piston to the hydraulic drive adapter and causes the flywheel to operate and provide the supplementary power.

### BACKGROUND

Uninterruptible power supplies, also known as uninterruptible power sources (UPS) are electrical apparatuses known in the art that provide emergency power to a load when the input power source, typically mains power, fails. A UPS differs from an auxiliary or emergency power system or standby generator in that it will provide near-instantaneous protection from input power interruptions, by supplying energy stored in batteries, supercapacitors, or flywheels. The on-battery runtime of most uninterruptible power sources is relatively short (only a few minutes) but sufficient to start a standby power source or properly shut down the protected equipment. A UPS is typically used to protect hardware such as industrial equipment, computers, data centers, telecommunication equipment or other electrical equipment where an unexpected power disruption could cause injuries, fatalities, serious business disruption or data loss. UPS units range in size from units designed to protect a single computer without a video monitor (around 200 volt-ampere rating) to large units powering entire data centers or buildings.

Rotary Flywheel UPS systems used in mission critical facilities provide very limited time to transition to back up generators after a power loss usually 15 to 45 seconds depending on the load. Theoretically, this “ride through” should be adequate to allow the backup generators to start. In the event that the backup generators fail to start, there is no time for an orderly shutdown of the systems. Costs associated with power failures are significant, and may collectively (billions of dollars annually). As an example, banks where millions of transactions are taking place every minute are exposed to significant losses during a power failure. Most mission critical facilities will install battery backup in order to provide adequate time for orderly shutdowns and to ensure that there is adequate time to get the backup generators started. Battery backup used to provide power to critical systems for an extended period of time is often expensive, requires dedicated space with special ventilation and fire protection systems, requires maintenance and is environmentally unfriendly among other things.

### SUMMARY

In one exemplary embodiment, an apparatus/system is disclosed for providing supplementary power, where the apparatus includes a vessel, configured to receive and contain fluid, a piston, configured within the vessel to be displaced by the fluid and provide pressure from the displacement, a fluid supply line, operatively coupled to an output of the vessel, a solenoid valve, operatively coupled to the fluid supply line; and a flywheel power supply, operatively coupled to the valve, wherein the flywheel power supply comprises a flywheel and a hydraulic drive adapter. The apparatus is configured to receive a signal indicating a power outage, the valve being further configured to open in response to the signal and provide fluid pressurized by the piston to the hydraulic drive adapter and cause the flywheel to operate and provide the supplementary power. The fluid may comprise at least one of an oil-based and water-based hydraulic fluid.

In other exemplary embodiments, the apparatus/system may further comprise a fluid reservoir and a hydraulic pump, wherein the hydraulic pump is configured to pump fluid from the fluid reservoir to the vessel. The fluid reservoir may be operatively coupled to the hydraulic drive adapter and configured to receive fluid discharged from the hydraulic drive adapter. The apparatus may further comprise a check valve operatively coupled between the hydraulic pump and the vessel via the fluid supply line, wherein the check valve may be configured to directionally control flow of fluid to the vessel. The apparatus may still further comprise a pressure regulator valve, operatively coupled to the solenoid valve, wherein the pressure regulator valve is configured to regulate pressure provided by the piston in the fluid supply line.

In other exemplary embodiments, a method is disclosed for providing supplementary power, wherein the method comprises the steps of receiving and containing hydraulic fluid in a vessel comprising a piston, positioned within the vessel, wherein the weight of the piston provides a pressure for the fluid in the vessel, and wherein the vessel is operatively coupled to a fluid supply line. The method may further comprise the steps of receiving a signal indicating a power outage, wherein receipt of the signal causes a solenoid valve to open and allow flow of fluid from the vessel to a hydraulic drive adapter of a flywheel power supply, and wherein the flow of fluid in the hydraulic drive adapter causes a flywheel of the flywheel power supply to operate and provide the supplementary power.

In other exemplary embodiments, the method comprises the steps of receiving fluid in the vessel comprises pumping fluid from a fluid reservoir, via a hydraulic pump, to the vessel. Fluid discharged from the hydraulic drive adapter may be received in the fluid reservoir. Fluid to the vessel may be directionally controlled via a check valve operatively coupled between the hydraulic pump and the vessel.

In still further embodiments, an apparatus/system is disclosed for providing supplementary power, comprising a vessel, configured to receive and contain hydraulic fluid, the vessel comprising a piston configured within the vessel to be vertically displaced by the hydraulic fluid and provide pressure from the weight of the piston to a fluid supply line. A solenoid valve may be operatively coupled to the fluid supply line. The apparatus may further include a flywheel power supply comprising a flywheel and a hydraulic drive adapter, wherein the hydraulic drive adapter is operatively coupled to the solenoid valve via the fluid supply line. The apparatus may be configured to receive a signal indicating a power outage, the solenoid valve being further configured to open in response to the signal and provide the hydraulic fluid pressurized by the piston to the hydraulic drive adapter and cause the flywheel to operate and provide the supplementary power.

In other exemplary embodiments, the apparatus/system may comprise a fluid reservoir and a hydraulic pump, wherein the hydraulic pump is configured to pump hydraulic fluid from the fluid reservoir to the vessel. The fluid reservoir may be operatively coupled to the hydraulic drive adapter and configured to receive hydraulic fluid discharged from the hydraulic drive adapter. A check valve may also be operatively coupled between the hydraulic pump and the vessel via the fluid supply line, wherein the check valve is configured to directionally control flow of fluid to the vessel. A pressure regulator valve may be operatively coupled to the solenoid valve, wherein the pressure regulator valve is configured to regulate pressure provided by the piston in the fluid supply line. The vessel may further comprise a sensor configured to sense an amount of hydraulic fluid in the vessel and provide a signal to the hydraulic pump to modify operation based on the sensed amount.

Further scope of applicability of the present disclosure will become apparent from the detailed description given hereinafter. However, it should be understood that the detailed description and specific examples, while indicating preferred embodiments, are given by way of illustration only, since various changes and modifications within the spirit and scope of the invention will become apparent to those skilled in the art from this detailed description.

### BRIEF DESCRIPTION OF THE FIGURES

The present invention is illustrated by way of example and not limitation in the figures of the accompanying drawings, in which like references indicate similar elements and in which:

FIG. 1 illustrates a hydraulic UPS system under one exemplary embodiment comprising a hydraulic fluid vessel/accumulator containing a sealed piston or weight for providing hydraulic fluid pressure that is released to a UPS flywheel when a solenoid valve is opened via a power failure signal;

FIG. 2 illustrates a hydraulic UPS system under another exemplary embodiment comprising a hydraulic fluid vessel/accumulator containing a sealed piston or weight for providing hydraulic fluid pressure that is released to a plurality of UPS flywheels when one or more solenoid valves are opened via a power failure signal; and

FIG. 3 illustrates a hydraulic UPS system under yet another exemplary embodiment comprising a plurality of hydraulic fluid vessel/accumulators each containing a sealed piston or weight for providing hydraulic fluid pressure that is released to a UPS flywheel when a solenoid valve is opened via a power failure signal.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

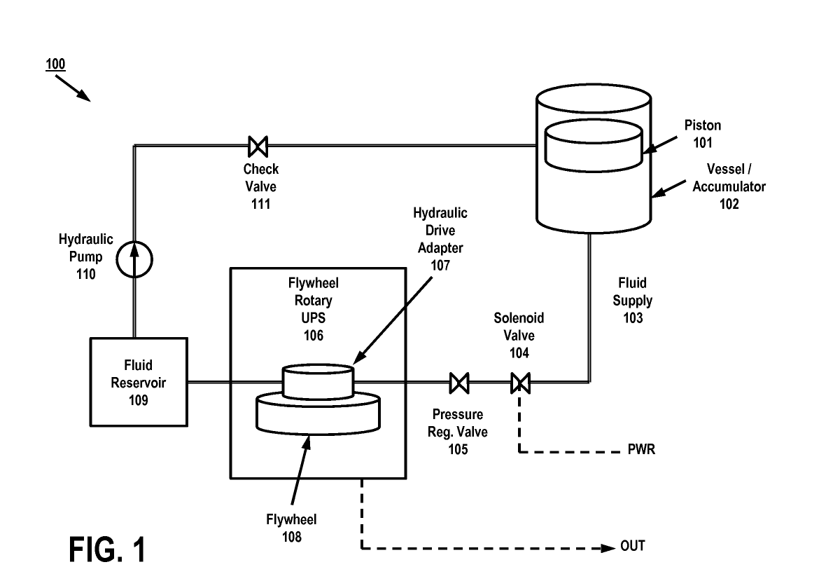

Turning to FIG. 1, an exemplary embodiment is provided of a UPS power system 100 comprising a piston 101 that is contained and preferably sealed within vessel/accumulator 102 (hereafter “vessel”). In one embodiment, piston 101 is manufactured from a dense and/or heavy material such as a metal or alloy (e.g., steel, tungsten, brass, etc) or plastic, rubber, or any suitable combinations thereof. Piston 101 may be coated or encased in a protective material to prevent corrosion and the like. Vessel 102 is filled with a fluid such as hydraulic fluid which may be oil or water-based fluid which may be provided from fluid reservoir 109, via hydraulic pump 110. Hydraulic pump may be a hydrostatic or hydrodynamic pump, depending on the application. When configured, hydraulic pump 110 provides positive displacement for piston 101 in which the displacement (flow through the pump per rotation of the pump) is fixed, or may be configured as a variable displacement pump, which allows the displacement to be adjusted. Flow from hydraulic pump 110 may be controlled via check valve 111.

As vessel 102 is filled with hydraulic fluid, the weight of piston 101 provides a counter-pressure within vessel 102. When vessel 102 is completely filled, the piston 101/vessel 102 may be considered at a maximum pressure. A hydraulic fluid supply line 103 is preferably coupled to a solenoid valve 104 which should be configured to be naturally in a “closed” state. In one embodiment, solenoid valve 104 is operatively coupled to a power system configured to provide a signal (PWR) indicating that power has failed, and that back-up power from system 100 is required. In one embodiment, solenoid valve 104 may be held in a closed position via a continuous PWR signal, indicating that power in a primary system is operating normally. Once power in the main system turns off, the PWR signal is no longer being received, causing solenoid valve 104 to open. As a result, the pressure from piston 101 causes fluid in vessel 102 to flow through valve 104 and pressure regulator valve 105 and into flywheel rotary UPS 106.

In one embodiment, UPS 106 operates under flywheel energy storage principles by accelerating a rotor, such as flywheel 108 via hydraulic drive adapter 107 to a very high speed and maintaining the energy in the system as rotational energy. When energy is extracted from the system, the flywheel's rotational speed may be reduced as a consequence of the principle of conservation of energy; adding energy to the system correspondingly results in an increase in the speed of the flywheel.

In a simplified embodiment, UPS 106 may comprise a rotor suspended by bearings inside a vacuum chamber to reduce friction, connected to a combination electric motor and electric generator. The flywheel may be a large steel flywheel rotating on mechanical bearings. In one embodiment, the flywheel may comprise carbon-fiber composite rotors that have a higher tensile strength than steel and are an order of magnitude less heavy. Magnetic bearings may be used used instead of mechanical bearings, to reduce friction. In one embodiment, high-temperature superconductor (HTSC) bearings or hybrid bearings may be used, where permanent magnets support a load and high-temperature superconductors are used to stabilize it. Superconductors may be advantageous in stabilizing a load because they may operate as diamagnets. If the rotor tries to drift off center, a restoring force due to flux pinning (magnetic stiffness of the bearing) restores it. Since flux pinning is a factor for providing the stabilizing and lifting force, the HTSC can be made much more easily for flywheel energy storage than for other uses. HTSC powders can be formed into arbitrary shapes so long as flux pinning is strong.

Compared with other techniques for storing electricity, flywheel energy storage systems have long lifetimes (lasting decades with little or no maintenance. Full-cycle lifetimes for flywheels may range from in excess of 10⁵, up to 10⁷, cycles of use), and provide high energy density (100-130 W·h/kg, or 360-500 kJ/kg), and large maximum power output. The energy efficiency (ratio of energy out per energy in) of flywheels can be as high as 90%. Typical capacities may range from 3 kWh to 133 kWh.

The energy density of flywheel 108 may vary, depending on the rotor geometry used and the properties of material being used. For single-material, isotropic rotors, this relationship may be expressed as

$$\frac{E}{m} = K ( \frac{σ}{ρ} ) ,$$

where E is the kinetic energy of the rotor (J), m is the rotor's mass (kg), K is the rotor's geometric shape factor, σ is the tensile strength of the rotor material (Pa) and ρ is the material's density (kg/m³).

Continuing with the example of FIG. 1, hydraulic fluid entering UPS 106 at a predetermined pressure specified by regulator valve 105 causes hydraulic drive adapter 107 to operate flywheel 108 for generating power (OUT) back to the main power system. In one embodiment, hydraulic fluid exiting UPS 106 is fed back to fluid reservoir 109, which regenerates the fluid for future use in vessel 102 via hydraulic pump 110. Thus, under normal operating conditions in one embodiment, flywheel 108 of the UPS is set to rotate at a high speed. Upon power failure, flywheel 108 continues to rotate to provide electrical power. When solenoid valve 104 opens, pressurized fluid flows, and continues to flow under pressure provided by piston 101. Hydraulic drive adapter 107 rotates as a result of the pressurized fluid and the flywheel continues to rotate until the fluid is completely discharged and piston 101 reaches the bottom of the vessel.

The embodiment of FIG. 1 (as well as other embodiments disclosed herein) provides a simple and elegant solution for providing uninterruptable power to a system using hydraulic technology. As pressure for the hydraulic fluid is being provided by the weight of piston 101 in one embodiment, the fluid may be easily regulated and input into UPS 106 for the creation of energy. Thus no expensive and/or complicated genset arrangements of secondary power origination are required. Of course, the piston arrangement in the present disclosure may be combined with such systems as required. Furthermore, pressure from piston 101 may be complimented and/or substituted by air pressure if necessary. In this embodiment, a bladder may be provided within vessel 102 and pressurized to achieve the required fluid pressure. Used alone, the inflated bladder would provide the pressure within vessel 102 to discharge the hydraulic fluid. Used in combination with piston 101, the bladder would provide additional pressure that that already being provided by the weight of piston 101. Such an embodiment may be advantageous when variable pressure may be required; the bladder would provide an efficient means for adding necessary pressure to the existing piston in the arrangement.

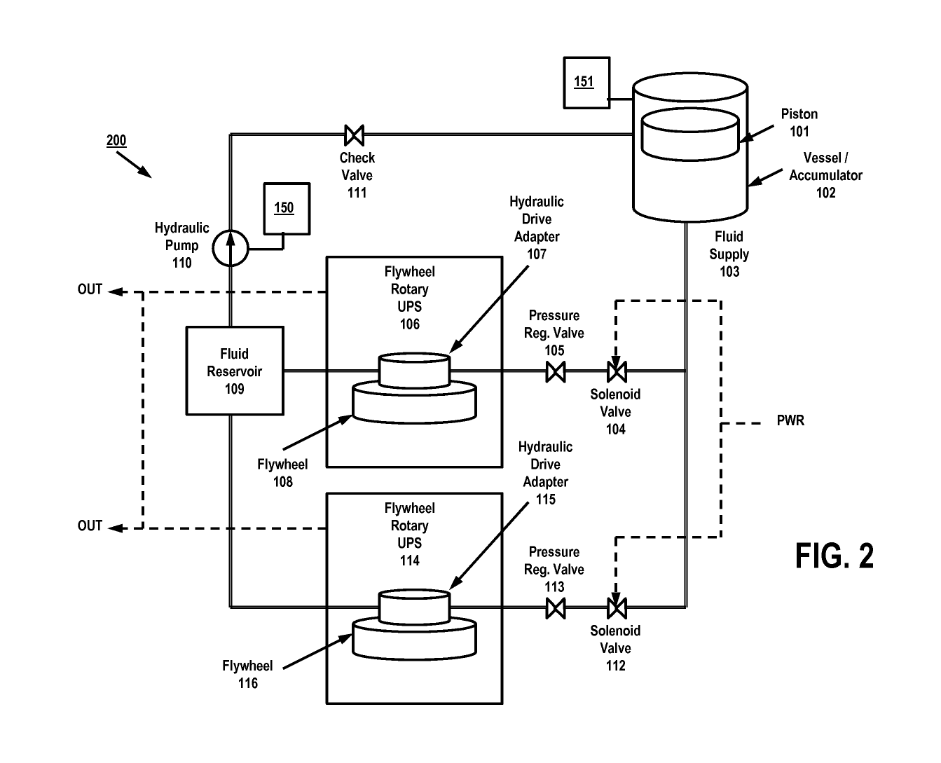

Turning to FIG. 2, another exemplary embodiment is provided, which is similar to the embodiment of FIG. 1, except that the piton 101 and vessel 102 configuration is used to provide fluid to a plurality of UPS systems (106, 114), where each of the UPS systems may provide separate backup power (OUT) to separate system, or alternately combined (shown by connecting dotted line between OUT signals in FIG. 2). Such a configuration may be advantageous in applications where (a) multiple, smaller UPS systems may be used in lieu of a more expensive, singular UPS, and/or (b) providing targeted UPS capabilities to multiple locations within a large installation.

The exemplary system 200 of FIG. 2 comprises a piston 101 that is contained and preferably sealed within vessel/accumulator 102 (hereafter “vessel”). Similar to the embodiment of FIG. 1, piston 101 may be manufactured from a dense and/or heavy material such as a metal or alloy (e.g., steel, tungsten, brass, etc.) or plastic, rubber, or any suitable combinations thereof. Piston 101 may be coated or encased in a protective material to prevent corrosion and the like. Vessel 102 is filled with a fluid such as hydraulic fluid which may be oil or water-based fluid which may be provided from fluid reservoir 109, via hydraulic pump 110. Hydraulic pump may be a hydrostatic or hydrodynamic pump, depending on the application. When configured, hydraulic pump 110 provides positive displacement for piston 101 in which the displacement is fixed, or may be configured as a variable displacement pump, which allows the displacement to be adjusted. Flow from hydraulic pump 110 may be controlled via check valve 111.

As vessel 102 is filled with hydraulic fluid, the weight of piston 101 provides a counter-pressure within vessel 102. When vessel 102 is completely filled, the piston 101/vessel 102 may be considered at a maximum pressure. A hydraulic fluid supply line 103 is preferably coupled to solenoid valves 104, 112 which may be configured to be naturally in a “closed” state. In one embodiment, solenoid valves 104, 112 are respectively coupled to a power system configured to provide a signal (PWR) indicating that power has failed, and that back-up power from system 200 is required. In one embodiment, solenoid valves 104, 112 may be held in a closed position via a continuous PWR signal, indicating that power in a primary system is operating normally. Once power in the main system turns off, the PWR signal is no longer being received, causing solenoid valves 104, 112 to open. As a result, the pressure from piston 101 causes fluid in vessel 102 to flow simultaneously through valves 104, 112 and pressure regulator valves 105, 113 and respectively into flywheel rotary UPS 106, 112.

Similar to the embodiment of FIG. 1, UPS 106 and 114 may operate under flywheel energy storage principles by accelerating a rotor, such as respective flywheels 108, 116 via hydraulic drive adapters 107, 115 to a very high speed and maintaining the energy in the system as rotational energy. When energy is extracted from the system (OUT), the flywheel's rotational speed may be reduced as a consequence of the principle of conservation of energy; adding energy to the system correspondingly results in an increase in the speed of the flywheel.

In the embodiment of FIG. 2, solenoid valves 104, 112 are controlled via the same PWR signal. It should be appreciated by those skilled in the art that separate, independent PWR signals may be provided to solenoid valves 104, 112, which in turn would provide separate backup power (OUT) for each UPS 106, 114. In this example, care should be taken to configure system 200 so that, for example, a prolonged use of one UPS (e.g., 114) does not drain hydraulic fluid to a point where the activation of another UPS (e.g., 106) does not create a scenario where insufficient fluid remains in vessel 102 to power a newly-activated UPS. In one embodiment, hydraulic pump may comprise one or more sensors (150) indicating the amount of fluid being pumped, and may further be in communication with one or more sensors (151) in vessel 102 which may monitor the amount of remaining fluid. In the event that an insufficient fluid supply condition is sensed, hydraulic pump 110 may be configured to increase pumping capacity from reservoir 109 to provide sufficient fluid to vessel 102.

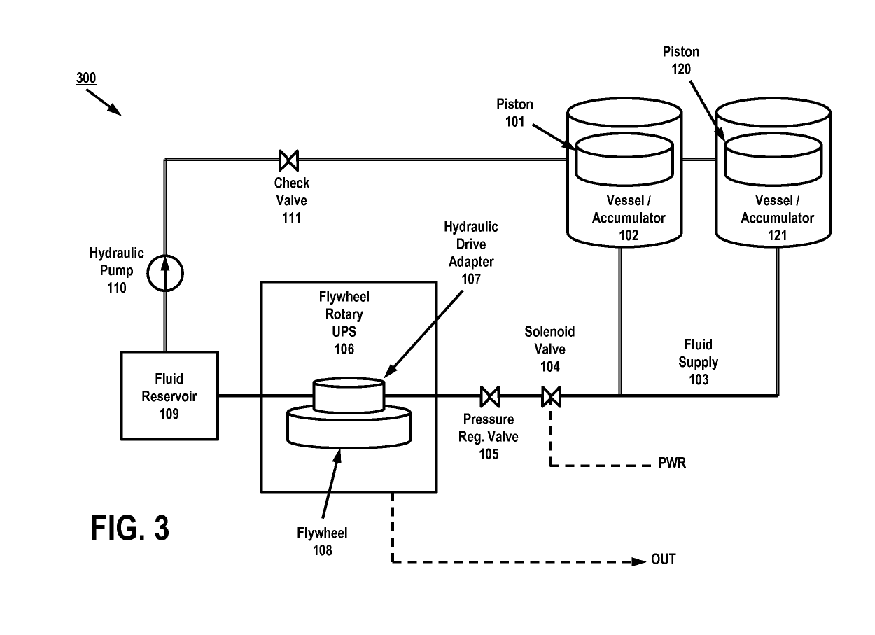

Turning to FIG. 3, another exemplary embodiment is provided, where multiple vessels (102, 121) and respective pistons (101, 120) are used to drive a UPS 106. Such a configuration may be advantageous for provided extended hydraulic backup capabilities to UPS 106. As similarly described above in connection with FIGS. 1-2, UPS power system 300 comprises pistons 101, 120 that are contained and preferably sealed within respective vessel/accumulators 102, 120. In one embodiment, pistons 101, 120 are manufactured from a dense and/or heavy material such as a metal or alloy (e.g., steel, tungsten, brass, etc) or plastic, rubber, or any suitable combinations thereof. Pistons 101, 120 may be coated or encased in a protective material to prevent corrosion and the like. Vessels 102, 121 are filled with a fluid such as hydraulic fluid which may be oil or water-based fluid which may be provided from fluid reservoir 109, via hydraulic pump 110. Hydraulic pump 110 may be a hydrostatic or hydrodynamic pump, depending on the application. When configured, hydraulic pump 110 provides positive displacement for pistons 101, 120 in which the displacement is fixed, or may be configured as a variable displacement pump, which allows the displacement to be adjusted. Flow from hydraulic pump 110 may be controlled via check valve 111.

As vessels 102, 121 are filled with hydraulic fluid, the weight of pistons 101, 120 provide a counter-pressure within vessels 102, 121. When vessels 102, 121 are completely filled, the respective piston weight may provide a maximum pressure. A hydraulic fluid supply line 103 is preferably coupled to both vessels 102, 121 and a solenoid valve 104 which should be configured to be naturally in a “closed” state. In one embodiment, solenoid valve 104 is operatively coupled to a power system configured to provide a signal (PWR) indicating that power has failed, and that back-up power from system 100 is required. In one embodiment, solenoid valve 104 may be held in a closed position via a continuous PWR signal, indicating that power in a primary system is operating normally. Once power in the main system turns off, the PWR signal is no longer being received, causing solenoid valve 104 to open. As a result, the pressure from pistons 101, 120 cause fluid in vessels 102, 121 to flow through valve 104 and pressure regulator valve 105 and into flywheel rotary UPS 106.

In one embodiment, vessels 102, 121 may operate to provide hydraulic fluid simultaneously. In another embodiment, vessels may be designated as “primary” (e.g., 102) and “secondary” (e.g., 121) vessels, and wherein the secondary vessel is equipped with its own solenoid (not shown). Each vessel may be equipped with sensors, similar to the embodiment of FIG. 2, where the level of fluid is sensed and monitored. Here, only the primary vessel (102) discharges hydraulic fluid upon activation of solenoid valve 104. As hydraulic fluid is drained, there may come a point where hydraulic pump 110 is not providing sufficient fluid back to vessel 102 to maintain UPS capabilities. If the sensed level of hydraulic fluid drops below a predetermined threshold, the sensor for the primary vessel activates a solenoid valve for the secondary vessel to provide a hydraulic fluid “assist” along a common fluid supply line 103. With the addition of fluid being provided by the secondary vessel 121, the primary vessel 102 does not have to expend as much fluid, which in turn may allow hydraulic pump 110 to “catch up” with any deficient fluids. If the fluid levels in the primary vessel 102 are raised back to an acceptable threshold, the sensor for the primary vessel 102 may close the solenoid for the secondary vessel. It should be understood by those skilled in the art that further vessels may be added, depending on the application, to create a daisy-chained configuration of vessels for extended UPS operation. Of course, the multiple vessel configuration of FIG. 3 may be combined with the multiple UPS configuration of FIG. 2 to provide still further operational UPS capabilities.

Continuing with the embodiment of FIG. 3, UPS 106 operates under flywheel energy storage principles by accelerating a rotor, such as flywheel 108 via hydraulic drive adapter 107 to a very high speed and maintaining the energy in the system as rotational energy. When energy is extracted from the system, the flywheel's rotational speed may be reduced as a consequence of the principle of conservation of energy; adding energy to the system correspondingly results in an increase in the speed of the flywheel.

In a simplified embodiment, UPS 106 may comprise a rotor suspended by bearings inside a vacuum chamber to reduce friction, connected to a combination electric motor and electric generator. The flywheel may be a large steel flywheel rotating on mechanical bearings. In one embodiment, the flywheel may comprise carbon-fiber composite rotors that have a higher tensile strength than steel and are an order of magnitude less heavy. Magnetic bearings may be used instead of mechanical bearings, to reduce friction. In one embodiment, high-temperature superconductor (HTSC) bearings or hybrid bearings may be used, where permanent magnets support a load and high-temperature superconductors are used to stabilize it.

Hydraulic fluid entering UPS 106 at a predetermined pressure specified by regulator valve 105 causes hydraulic drive adapter 107 to operate flywheel 108 for generating power (OUT) back to the main power system. In one embodiment, hydraulic fluid exiting UPS 106 is fed back to fluid reservoir 109, which regenerates the fluid for future use in vessel 102 via hydraulic pump 110.

In the above configurations, the flywheel UPS may be configured to continuously rotate by getting power from the grid. Accordingly, the output power is advantageously protected from power distortions from the grid. In an alternate embodiment, power may be provided to the flywheel UPS and to the pump. In such a configuration, the power to the UPS is continuous, and the power to the pump is only needed after power is restored, where the pump is utilized to refill and re-pressurize the vessel. As the pump is continuously running, this would cause the flywheel to rotate, which in turn may vitiate the need for a power supply to the flywheel UPS. Such a configuration would be advantageous in reducing installation costs.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. An apparatus for providing extend runtime for a flywheel rotary UPS, comprising:
a vessel, configured to receive and contain fluid;
a piston having a predetermined weight, configured within the vessel to have the weight of the piston independently and vertically displaced by the fluid and provide pressure from the displacement;
a fluid discharge line, operatively coupled to an output of the vessel;
a valve, operatively coupled to the fluid discharge line;
a fluid supply line operatively coupled to the valve;
a hydraulic drive adapter operatively coupled to the fluid supply line; and
a flywheel rotary UPS operatively coupled to the hydraulic drive adapter, wherein the flywheel rotary UPS is configured to rotate when power is being provided to the flywheel rotary UPS,
wherein upon power failure to the flywheel rotary UPS, the valve is configured to open and provide fluid pressurized by the piston to the hydraulic drive adapter and cause the flywheel rotary UPS to continue rotating for an extended period of time after power to the flywheel rotary UPS has failed.

2. The apparatus of claim 1, wherein the fluid comprises at least one of an oil-based and water-based hydraulic fluid.

3. The apparatus of claim 1, further comprising a fluid reservoir and a hydraulic pump, wherein the hydraulic pump is configured to pump fluid from the fluid reservoir to the vessel.

4. The apparatus of claim 3, wherein the fluid reservoir is operatively coupled to the hydraulic drive adapter and configured to receive fluid discharged from the hydraulic drive adapter.

5. The apparatus of claim 4, further comprising a check valve operatively coupled between the hydraulic pump and the vessel via the fluid supply line, wherein the check valve is configured to directionally control flow of fluid to the vessel.

6. The apparatus of claim 1, wherein the valve comprises a solenoid valve.

7. The apparatus of claim 5, further comprising a pressure regulator valve, operatively coupled to a solenoid valve, wherein the pressure regulator valve is configured to regulate pressure provided by the piston in the fluid supply line.

8. A method for providing extended run time for a flywheel rotary UPS system, comprising:
receiving and containing fluid in a vessel comprising a piston having a predetermined weight, positioned within the vessel, wherein the weight of the piston provides a pressure for the fluid in the vessel via an independent vertical displacement of the weight of the piston by the fluid, and wherein the vessel is operatively coupled to a fluid supply line;
operatively rotating a flywheel of a flywheel power supply when power is being supplied to the system; and
opening a valve when power supplied to the flywheel power supply has failed to allow flow of fluid from the vessel to a hydraulic drive adapter of the flywheel power supply, wherein the flow of fluid in the hydraulic drive adapter causes a flywheel of the flywheel power supply to continue rotating for an extended period of time after power supplied to the flywheel power supply has failed.

9. The method of claim 8, wherein the fluid comprises at least one of an oil-based and water-based hydraulic fluid.

10. The method of claim 8, further comprising the step of receiving fluid in the vessel comprises pumping fluid from a fluid reservoir, via a hydraulic pump, to the vessel.

11. The method of claim 10, further comprising the step of receiving fluid discharged from the hydraulic drive adapter in the fluid reservoir.

12. The method of claim 11, further comprising the step of directionally controlling flow of the fluid to the vessel via a check valve operatively coupled between the hydraulic pump and the vessel.

13. The method of claim 8, wherein the valve comprises a solenoid valve.

14. The method of claim 13, further comprising the step of regulating pressure provided by the piston in the fluid supply line via a pressure regulator valve, operatively coupled to the solenoid valve.

15. An apparatus for providing extended run time for a flywheel rotary UPS, comprising:
a vessel, configured to receive and contain hydraulic fluid, said vessel comprising
a piston having a predetermined weight and configured within the vessel to have the weight independently and vertically displaced by the hydraulic fluid and provide pressure from the weight of the piston to a fluid supply line;
a solenoid valve, operatively coupled to the fluid supply line; and
a flywheel power supply comprising a flywheel and a hydraulic drive adapter, wherein the flywheel power supply is configured to rotate when power is being supplied to the flywheel power supply, and wherein the hydraulic drive adapter is operatively coupled to the solenoid valve via the fluid supply line,
wherein upon power supply failure to the flywheel power supply the solenoid valve is configured to open and provide the hydraulic fluid pressurized by the piston to the hydraulic drive adapter and cause the flywheel to continue rotating for an extended period of time after power to the flywheel power supply has failed.

16. The apparatus of claim 15, further comprising a fluid reservoir and a hydraulic pump, wherein the hydraulic pump is configured to pump hydraulic fluid from the fluid reservoir to the vessel.

17. The apparatus of claim 16, wherein the fluid reservoir is operatively coupled to the hydraulic drive adapter and configured to receive hydraulic fluid discharged from the hydraulic drive adapter.

18. The apparatus of claim 17, further comprising a check valve operatively coupled between the hydraulic pump and the vessel via the fluid supply line, wherein the check valve is configured to directionally control flow of fluid to the vessel.

19. The apparatus of claim 15, further comprising a pressure regulator valve, operatively coupled to the solenoid valve, wherein the pressure regulator valve is configured to regulate pressure provided by the piston in the fluid supply line.

20. The apparatus of claim 18, wherein the vessel further comprises a sensor configured to sense an amount of hydraulic fluid in the vessel and provide a signal to the hydraulic pump to modify operation based on the sensed amount.
